(19) United States
(12) Patent Application Publication
(10) Pub. No.: US 2007/0039980 A1
(43) Pub. Date: Feb. 22, 2007

(54) Pouring spout for a container including a liquid, container, method and use hereof

(76) Inventors: Lasse Kjeldsen, Kvaemdrup (DK); Peter William Nash, Veflinge (DK); Erik Langelund, Gislev (DK)

Correspondence Address: CANTOR COLBURN, LLP, 55 GRIFFIN ROAD SOUTH, BLOOMFIELD, CT, 06002, US

(21) Appl. No.: 10/556,858

(22) PCT Filed: Apr. 27, 2004
(86) PCT No.: PCT/DK04/00288

§ 371 Date: Nov. 9, 2006

(30) Foreign Application Priority Data
May 14, 2003 (DK) PA 2002 00737

(51) Int. Cl. B67D 3/00; B65D 25/40

(52) U.S. Cl. 222/514; 222/501; 222/518

(57) ABSTRACT

The invention relates to a pouring spout (1) for a container holding a liquid, said spout comprising outer tubular means (2) and inner tubular means (3) with an inner passage (11) for said liquid from the container to the exterior. The inner tubular means (3) being partly or totally integrated in said outer tubular means (2) and said means being movable in relation to each other. The spout further comprises a stick (4) including closing means (5) at one end for closing or opening said inner passage (11) by movement of said outer or inner tubular means in relation to each other. The invention also relates to a container, a method and use hereof.

### BACKGROUND OF THE INVENTION

The invention relates to a pouring spout as specified in the preamble of claim 1, a container as specified in the preamble of claim 30, method and use hereof.

Containers for pourable media that are available on the market today are in the main characterized by having, pouring spouts on which a closing mechanism of some sort or other is attached, e.g. a screw cap. Such closing mechanisms are removed manually to enable the container's content to be poured out, and while the closing mechanism is off there is a risk that the container will topple over, causing the container's content to spill out in an uncontrolled fashion. Likewise, the closing mechanism must be manually attached again in order to close the container once more, and in this state it is no longer possible to pour the container's content out. The desire to avoid the time consuming manual intervention that is necessary in order to move from the one state to the other has lead to different inventions.

A closing mechanism is known that may be seen attached to bottles often used by people active in the field of sport. The closing mechanism is opened by using fingers or teeth to pull it forward and closed by using fingers or teeth to push it back, whereby the mechanism either allows or prevents the outflow of the bottle's content when it is raised to the pouring position.

The problem with this method of activation is that although it shortens the time necessary to change from the closed to the open position and vice versa, it still retains the weakness inherent in manual closing mechanisms, i.e. should the bottle topple with the closing mechanism in the open position, the bottle's content will flow out in an uncontrolled manner.

Also, a pouring spout is known that is for attaching to mainly wine bottles, and which allows the outflow of liquid when the bottle is raised to the pouring position. The pouring spout does not possess the ability to close the bottle when the bottle is placed in an upright position. Should the bottle topple over, however, the unintentional outflow of the bottle's content is prevented by a closing mechanism, which consists of a metal orb that rolls forward into the pouring spout as the bottle is toppling, thereby blocking the mouth of the pouring spout. The aforesaid metal orb remains in the mouth of the pouring spout even after the bottle has been lifted to the vertical position once more, and it requires manual intervention, e.g. in the form of a prod by a finger, to induce the metal orb to retract from the mouth of the pouring spout.

The problem with manual intervention of the stated kind is that it can accommodate the introduction of bacteria to the liquid in the container.

Furthermore, a pouring spout for a container is known from International patent application no. WO-A 9618552, wherein is described a self-closing extraction mouthpiece for attachment to containers for liquid media. It consists of an extraction pipe fitted inside a valve housing. The extraction pipe is sealed at the bottom, but has a hole in its side. The bottom of the extraction pipe is held sealingly against a valve seat by means of a screw spring positioned between the valve housing and a pressure cover, thereby preventing the outflow of the liquid through the extraction pipe. When the screw spring is depressed by pressure of the mouth against the pressure cover, the hole in the extraction pipe is projected beneath the valve seat, thereby allowing the outflow of liquid through the extraction pipe. The extraction mouthpiece can be kept closed by turning the pressure cover clockwise when the extraction mouthpiece is in the closed position. This closing means is described variously as a means to prevent unintentional movement of the extraction pipe away from the closing position, a child safety means and a means to prevent the leaking out of carbonic acid gas from a beverage containing the same.

The problem with the said self-closing extraction mouthpiece is that the hole in the side of the extraction pipe is necessarily relatively small in relation to the diameter of the extraction pipe itself and is limited still further by the distance the extraction pipe can move when the pressure cover is depressed. The thinly-fluid liquid must be extracted through this hole and at the same time the influx of air to assist the outflow of the liquid must take place through the same hole and at the same time. This will lead to the outflow not having a satisfactory strength and to the need to depress the outside of the container in order to assist the extraction. Another problem with the self-closing extraction mouthpiece as described is that it requires manual intervention to activate a locking mechanism to prevent the uncontrolled outflow of the liquid should the container topple and also to prevent the leaking out of carbonic acid gas from beverages containing such a gas.

The object of the invention is to establish a pouring spout without the above-mentioned disadvantage as will be explained in the following and especially with an enhanced ability to open and close for the outflow of liquid.

### THE INVENTION

The invention relates to a pouring spout, said spout further comprises a stick including closing means at one end for closing or opening said inner passage by movement of said outer or inner tubular means in relation to each other. Hereby it is possible to establish a spout without the abovementioned disadvantages.

Further, it is possible utilise the full diameter of the inner passage when said inner passage is open to expedite the outflow of the liquid included in the container to the exterior.

In an aspect of the invention, said stick including closing means is moved from a first position to one or more further positions in which one or more of said positions are defined. Hereby is achieved an ability to open the invention and maintain it in its open position, or to lock the invention and maintain it in its locked position, or to adjust the invention so that it without any additional manual intervention is open when it is required to be open and is closed when it is required to be closed. The transition from the one to the other position takes place quickly and easily so that all the advantages described in the following are to be considered to be parts of a superior main advantage.

The advantage of holding the invention in an open position is that it is then always possible to pour the thinly-fluid liquid from the container and into another container, such as a drinking glass. The advantage of holding the invention in a closed position is that it is then possible to prevent the thinly-fluid liquid from escaping the container. The advantage of adjusting the invention so that it without any additional manual intervention is open when it needs to be open and is closed when it needs to be closed is that the thinly-fluid liquid may be emptied from the container when required, and yet should the container e.g. topple over, the liquid remains in the container, whether or not the container topples over on the same plane or onto a lower plane. An additional advantage is that should the container topple over, the thinly-fluid liquid may be immediately extracted from the container without any additional manual intervention as soon as the container has been righted once more.

These different possibilities ensure that any user of the invention can firstly, choose a principle of usage that suits the container to be used, and secondly, choose a principle of usage that suits his or her temperament and the usage situation in which he or she is involved in, since all the described possibilities are built into the invention.

In an aspect of the invention, said inner tubular means may be connected to the container, e.g. by entering into an opening of said container or by surrounding a rim of an opening of said container or by being attached to the end of a rim of an opening of said container. The advantage of this aspect of the invention is that it does not matter whether the opening of the container is of a relatively thick or a relatively thin material or whether the opening of the container has a screw thread or not.

In an aspect of the invention, said spout includes a section comprising an opening with a rim for pouring to the exterior, said section being opposite the section comprising an opening toward the interior of the container and said openings each define a beginning of said inner passage. The advantage of this aspect of the invention is that it provides a direct connection between the liquid in the container and the exterior of the container, the liquid entering at one end and exiting at the other.

In an aspect of the invention, said closing means is for closing and opening at one of said two openings. The advantage of this aspect of the invention is that it immediately facilitates or prevents the outflow of the liquid in the container to the exterior of the container by opening or closing said inner tubular means. It has the added advantage of being independent of the shape or construction of said opening.

In an aspect of the invention, a container connection section includes sealing rings such as O-rings or rims in rubber or rubber-like materials. The advantage of this aspect of the invention is that it provides an effective and tight connection between the invention and the container.

In an aspect of the invention, said stick is connected to said outer or inner tubular means with holding or connection means comprising one or more openings. The advantage of this aspect of the invention is that it ensures an expedient steering of the backward and forward movement of the stick with closing means. It also has the advantage of being independent of whether the thinly-fluid liquid is poured from the container or whether the thinly-fluid liquid is drunk directly from the container.

In an aspect of the invention, said one or more openings in said holding or connection means are part of said inner passage. Hereby is achieved the positioning and steering of said stick and said closing means within the inner tubular means between one end of the inner passage and the other end of the inner passage. This aspect of the invention also has the added advantage that it allows for a better transmission of the thinly-fluid Liquid through the inner passage, since said opening or openings also allow air to enter the container at the same time as the liquid is leaving it.

In an aspect of the invention, said stick is positioned in the centre of said inner and/or outer tubular means along a centre line of said inner and/or outer tubular means. The advantage of this aspect of the invention is that said stick, said outer tubular means and said inner tubular means may move parallel to each other, which ensures that said closing means fits uniformly tightly against said inner passage. It also has the added advantage of ensuring that when backward and forward movement of said stick takes place, such movement will take place without wobble.

In an aspect of the invention, said stick is held transversally in place by holding means extending from the inner surface of said inner tubular means, said holding means allowing the stick to move in the longitudinal direction. Hereby is achieved the opening and closing of the inner tubular means. This aspect of the invention also has the advantage that said holding means guides said stick and ensures that said stick follows said centre line for the outer tubular means and said inner tubular means.

In an aspect of the invention, said holding means comprises at least one ring or similar shaped means connected to said inner surface of said inner tubular means by supporting arms. The advantage of this aspect of the invention is that said support arms provide added strength to said holding means. An added advantage is that the positioning of said support arms facilitates the influx of air to the container and at the same time facilitates the outflow of thinly-fluid liquid to the exterior of said container.

In an aspect of the invention, said outer tubular means is movable in the longitudinal direction in relation to said inner tubular means and by a circular movement around said centre line. The advantage of this aspect of the invention is that it allows for activities other than the opening and closing of said inner tubular means.

In an aspect of the invention, said outer tubular means includes at least one opening or recess defining a movement area of at least one pin connected to the outer surface of said inner tubular means. This aspect of the invention allows the positioning of said pin at various locations in said movement area. Hereby is achieved the possibility of ensuring at least three different methods of usage of the invention and the possibility of providing the invention with one or more methods of closing.

In an aspect of the invention, said inner tubular means includes at least one recess defining a movement area of at least one pin connected to the inner surface of said outer tubular means. Hereby are achieved the same advantages as described in the previous aspect of the invention.

In an aspect of the invention, said movement area comprises at least two openings or recesses being perpendicular or parallel to said centre line. Hereby is achieved both the possibility of locking said stick including closing means in said perpendicular openings or recesses by positioning said pin or pins in said perpendicular recesses and of allowing said stick with closing means to wander freely by positioning said pin or pins in said parallel openings or recesses.

In an aspect of the invention, said first or further openings or recesses being perpendicular to each other form one or more successive S shapes. This aspect of the invention has the advantage of providing the invention with enhanced flexibility of usage.

In an aspect of the invention, said movement area comprising a first and third opening or recess being perpendicular to the centre line, establish two defined positions for said stick including closing means, e.g. an opened and a closed position for said inner passage. Hereby is achieved the possibility of both ensuring the invention is locked in one situation, ensuring the invention is open in another situation and ensuring the invention has the option of wandering between both open and closed, by positioning said stick including closing means in said perpendicular openings or recesses.

In an aspect of the invention, said first and/or third opening or recess comprise at least one bulge to secure said at least one pin in one of said defined positions. This provides the advantage of added locking security to the invention, thereby making it more difficult for a child to unlock it.

In an aspect of the invention, comprises at least one controlling rod, being in one configuration of the invention fixed to said holding and connection means, and in another configuration of the invention movably held in one or more of said holding or connection means, e.g. sliding in holes penetrating said holding or connection means.

In an aspect of the invention, at least one controlling rod is positioned between said stick and the inner surface of said inner tubular means, e.g. in sets on opposite sides of the stick.

In an aspect of the invention, said inner and outer tubular means comprise activating means. Hereby is achieved the possibility of achieving an automatic closing of the invention once it has been opened. An added advantage of said activating means is that they may be used alone or in combination, according to which and/or how much thinly-fluid liquid is in the container.

In an aspect of the invention, said activating means includes spring activating means acting against an interior surface of said inner and outer tubular means, or against an interior surface of said inner tubular means and said holding means, or against an interior surface of said tubular means and said connecting means.

In an aspect of the invention, said activating means includes magnetic material in connection with material sensible to magnetic fields or vice versa, acting within said inner tubular means or against an inner surface of said outer tubular means or an outer surface of said inner tubular means.

In an aspect of the invention, said activating means includes magnetic material in connection with said stick and material sensible to magnetic fields in connection with said inner tubular means or vice versa and spring activating means acting against an interior surface of said inner or outer tubular means and a surface of said stick in order to force said stick including closing means toward a closing position of said inner passage. The advantage of a combination of a ‘spring’ closing means and a ‘magnet’ closing means is that the magnet will assist in preventing the unintentional depression of the spring in the case of a container with the invention attached falling from one level to a much lower level.

In an aspect of the invention, some or all means of the pouring spout such as said inner and outer tubular means are made of a plastic material or any material capable of being moulded, extruded, milled or similarly modified.

In an aspect of the invention, said closing means is made of a rubber or other similarly flexible material.

In an aspect of the invention, the surface of said spout includes an adaptor for holdings normal closing means of the container. The advantage of said adaptor is that it provides a logical temporary method of safekeeping of said normal closing means, in cases where the repayment of a deposit on a container demands that the container also includes said normal closing means.

In an aspect of the invention, said adaptor includes a rim and a screw thread corresponding to that on the normal closing means of the container. The advantage of this aspect of the invention is that said normal closing means will remain firmly on said adaptor until it becomes necessary to remove it.

Any container for containing liquid having at least one opening for pouring liquid is suitable for use in connection with the invention comprising any of the invention's aspects controlling the pouring of said liquid through said at least one opening.

Furthermore, the invention may be an integrated part of said container or a separate part mounted on said container.

In an aspect of the invention, said pouring spout is a separate part mounted on said container with an adapting means in between the spout and the neck or opening of said container for adapting diameters of said spout and neck or opening. The pouring spout is hereby suitable for use on containers of different sizes and with different types of thinly-fluid liquids, both gaseous and flat. The pouring spout is suitable for use on containers with mouthpieces of different sizes and different shapes.

Furthermore, the method of controlling the pouring of said liquid from said container comprises the steps of:

moving an outer or inner tubular means of the invention in relation to each other,

and hereby

moving a stick including closing means of the invention from a first position to one or more further positions in which one or more of said positions are defined.

In an aspect of said method of controlling the pouring of said liquid, said stick including closing means may be moved between at least the following positions:

a first defined position closing the liquid passage of the spout by said closing means being forced against an opening of the liquid passage,

a second defined position in which the liquid passage of the spout is open by said closing means being held at a distance from said opening of the passage, and

at least one further position allowing said closing means to move freely between said first and second position.

When the pouring spout is in its ‘neutral’ position i.e. when the pin in the recess is not in either the ‘locked’ or the ‘open’ position, the container may topple over without the liquid in the container being able to exit the container through the pouring spout, and this no matter whether the liquid is gaseous or flat.

When the container that has fallen over is righted again, it is ready for use without any external intervention being required in relation to the pouring spout.

When the pouring spout is in the ‘neutral’ position, it is possible to drink from the container through the pouring spout by applying lip pressure to the mouthpiece of the pouring spout.

When the pouring spout is in the ‘neutral’ position, and its outer tubular means at the same time has been provided with a collar around its circumference, it is possible to pour out the liquid from the container through the pouring spout by holding on to the container with one hand and using fingers on the other hand to depress the collar.

When the pouring spout is in the ‘neutral’ position, and its outer tubular means at the same time has been provided with a collar around its circumference, it is possible to suspend the container, with its mouthpiece pointing towards the floor, in a frame, and by pressing upwards against the collar with e.g. a drinking glass cause the liquid in the container to flow out, until such time as the glass is once more removed from contact with the collar. When the pouring spout is in the ‘open’ position, it is possible to pour out the liquid from the container. When the pouring mechanism is in the ‘locked’ position it is neither possible to pour nor to drink from the container.

The change from the ‘locked’ to the ‘neutral’ position takes place quickly and without risk of error. The change from the ‘open’ position to the ‘neutral’ position takes place quickly and without risk of error. The change from the ‘open’ to the ‘locked’ position takes place quickly and without risk of error. The change from the ‘locked’ position to the ‘open’ position takes place quickly and without risk of error.

The invention is for use on containers such as bottles containing milk, fruit juice, cordial, lemonade, wine, beer or soft drinks e.g. drinks comprising carbon dioxide.

### FIGURES

The invention will be described in the following with reference to the figures in which

FIGS. 1a to 1c show a first preferred embodiment of the pouring spout including sectional views according to the invention;

FIGS. 2a and 2b show a second embodiment of the pouring spout comprising an opening defining the movement of the outer tubular means;

FIGS. 3a and 3b show a third embodiment of the pouring spout illustrating the stick including the closing means in an open position, and with an adaptor for attaching a normal closing means of a container;

FIGS. 4a to 4c show a fourth embodiment of the pouring spout according to the invention illustrating the stick with closing means in an open position, an alternative outer tubular means and activating means;

FIG. 5 shows a fifth embodiment of the pouring spout with further activating means;

FIG. 6 shows a sixth embodiment of the pouring spout according to the invention illustrating the stick with closing means in an open position, yet another alternative outer tubular means and activating means;

FIGS. 7a and 7b show a seventh embodiment of the pouring spout illustrating an alternative opening towards the exterior;

FIG. 8 shows a eighth embodiment illustrating an alternative positioning of the spring activating means;

FIGS. 9a to 9c show an ninth embodiment of the pouring spout illustrating an alternative positioning of the stick with closing means, said stick with closing means being in an open position;

FIGS. 10a to 10c show different embodiments of the pouring spout and different embodiments of the activating means with different placements of these within the inner passage of the pouring spout,

FIGS. 11a and 11b show a further embodiment of the pouring spout illustrating an alternative outer tubular means with collar,

FIG. 12 show the connection of a pouring spout according to the invention to a container with the use of an adapting means, and

FIG. 13, shows the functionality of an embodiment of the pouring spout.

### DETAILED DESCRIPTION

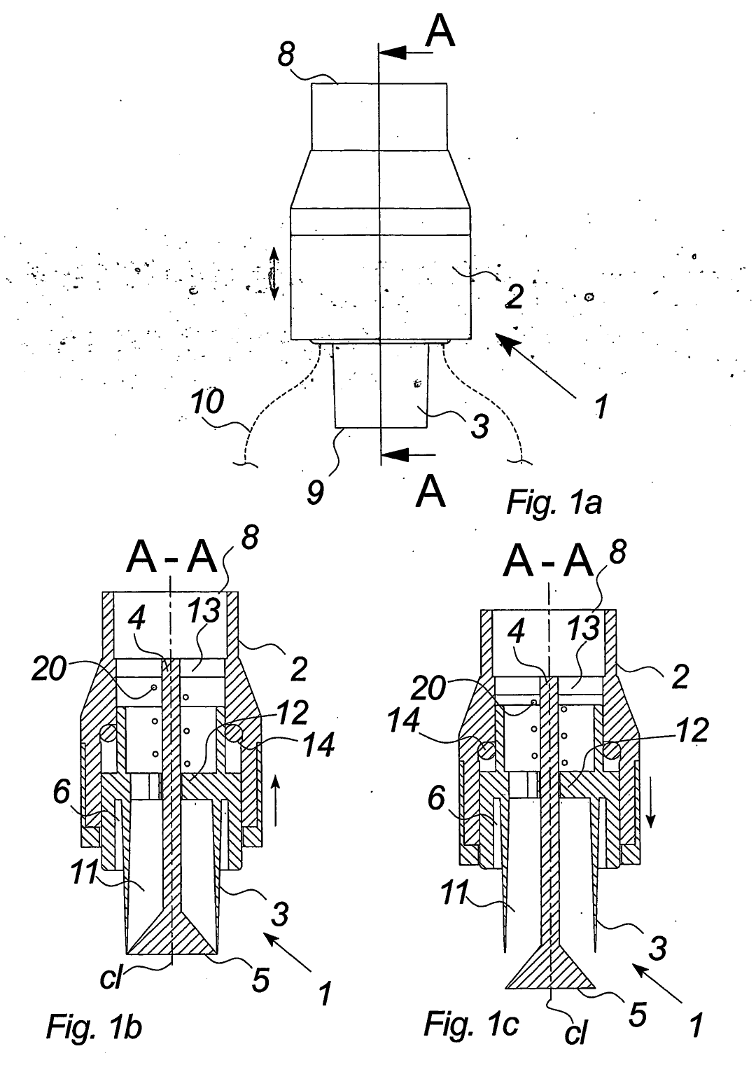

FIG. 1a shows a pouring spout 1 including an outer tubular means 2 and an inner tubular means 3, with an opening towards the exterior 8 shown at the top of the outer tubular means 2 and an opening into the container 10 shown at the bottom of the inner tubular means.

The arrow to the left of the pouring spout 1 illustrates the directions that the outer tubular means 2 of this embodiment may at least be moved in relation to the inner tubular means 3 and the container 10.

FIG. 1b shows a sectional drawing of a pouring spout 1, including an outer tubular means 2 and an inner tubular means 3. Attached to the inner surface of the outer tubular means 2 is a connection means 13. Attached to the inner surface of the inner tubular means is a holding means 12. A stick 4 with closing means 5 passes along a centre line for said outer tubular means 2 and inner tubular means 3 through the holding means 12 and is attached to the connection means 13. The closing means 5 is shown sealing the opening into the interior of the inner passage 11 of the pouring spout 1. In the inner passage, between the holding means 12 and the connection means 13 and around the stick 4, is positioned a spring activating means 20.

The sectional drawing to the left (FIG. 1b) illustrates the pouring spout 1 in a closed position e.g. a position in which no outside force is applied to the pouring spout 1. The spring activating means 20 forces the outer tubular means 2 upward whereby the closing means 5 of the stick 4 meets the lower edge of the inner tubular means 3. By the forcing the closing means 5 against the inner tubular means 3 it is ensured that the inner passage 11 of the pouring spout 1 is tightly closed.

The sectional drawing to the right (FIG. 1c) illustrates the pouring spout 1 in an opened position e.g. by the user applies a downward force to the outer tubular means 2 while holding the container (partly illustrated in FIG. 1a). The spring activating means 20 is forced together in between the inner tubular means 3 and the outer tubular means 2 by the movement of the outer tubular means 2. The closing means 5 of the stick 4 is separated from the lower edge of the inner tubular means 3 by the downward movement. The inner passage 11 of the pouring spout 1 is hereby open and the pourable media may flow through the pouring spout 1 e.g. from the container to the mouth of the user.

Between the outer tubular means 2 and the inner tubular means 3 is shown a sealing means 14 in FIG. 1b and 1c. The sealing means is preferably a standard rubber O-ring held in place by a projecting edge at the inner surface of the outer tubular means 2. The edge projects just below the O-ring and stops it from rolling down during movements of the inner tubular means 3.

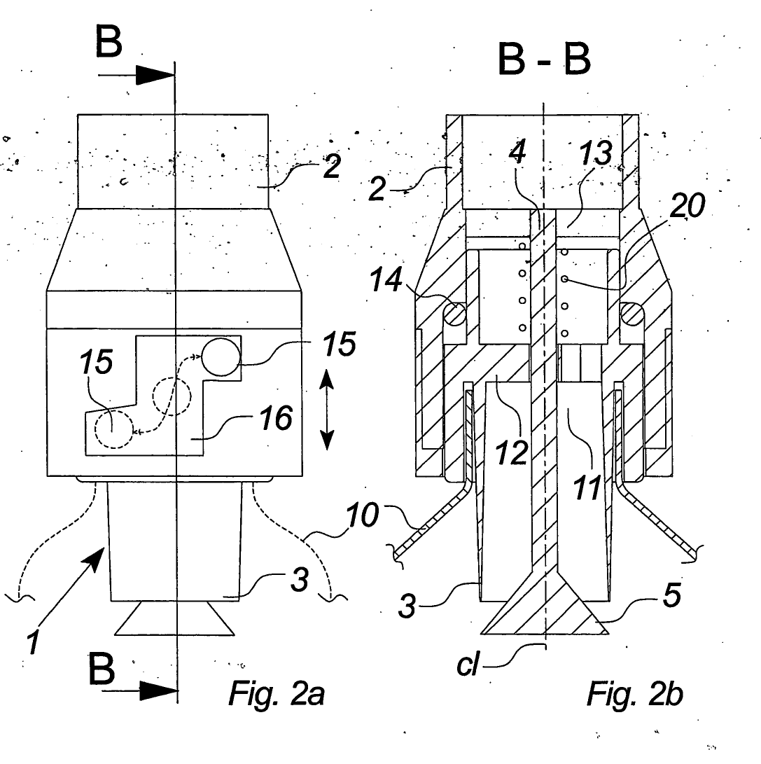

FIG. 2a shows a pouring spout 1, including an inner tubular means 3 and an outer tubular means 2. On the outer tubular means 2 is shown a movement area 16, of which both the upper and lower sections are depicted perpendicular to the centre line B and the middle section is perpendicular to these sections. In the lower section of movement area 16 is shown a pin 15. At the same time an arrow depicts other possible positions of the pin 15, namely in the upper section of movement area 16 and in the section perpendicular to the upper and lower sections of movement 16.

FIG. 2b shows a sectional drawing of FIG. 2a, providing a view of the inner passage 11. Between the outer tubular means 2 and the inner tubular means 3 is shown sealing means 14. Within the inner passage 11 may be seen the stick 4 with closing means 5 situated along a centre line cl and attached to a connection means 13 and passing through a holding means 12. The holding means 12 may comprise one or more vertically though-going holes.

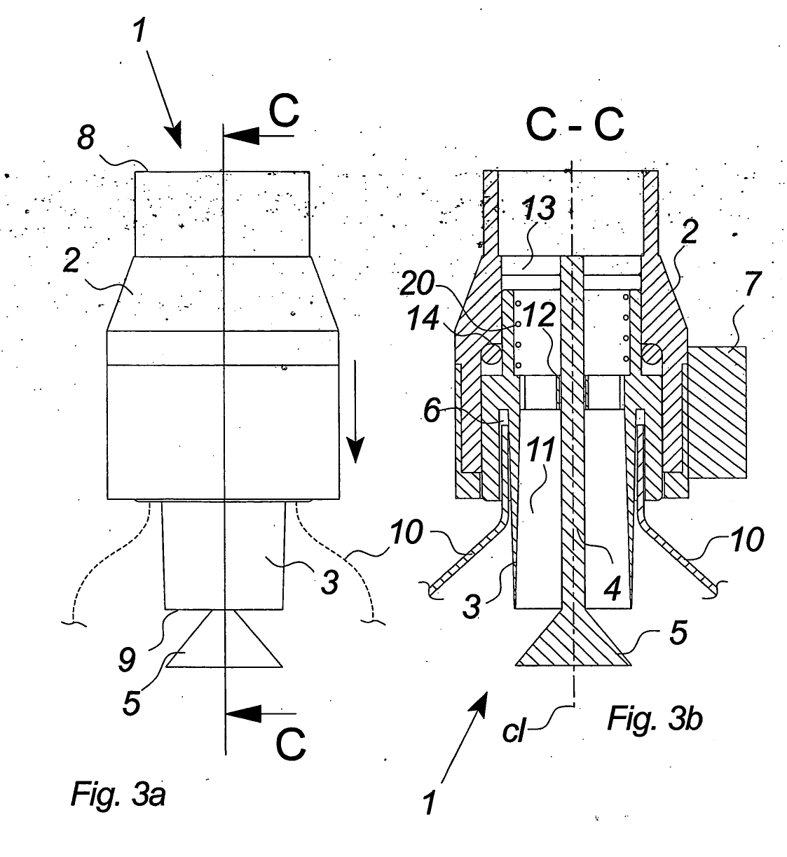

FIG. 3a shows a pouring spout 1, including an opening towards the exterior 8 on the outer tubular means 2 and an opening into the container 9 on the inner tubular means 3. The closing means 5 is shown in an open position.

FIG. 3b shows a sectional drawing of FIG. 3a depicting how the inner tubular means 3 in one embodiment may fit into a container and around the rim or neck of a container 10 by means of the container connection section 6. The outer tubular means 2 is shown fitting around the inner tubular means 3, and to the outer surface of the outer tubular means is shown an adaptor 7 for holding a container's normal closing means, e.g. a cap, a cork or a stopper of a bottle. Within the inner passage 11 is shown the stick 4 attached to connection means 13 and passing through holding means 12, with the closing means 5 in an open position and positioned on the centre line c1. A spring activating means 20 in a compressed state is situated between the connection means 13 and the holding means 12 and around the stick 4.

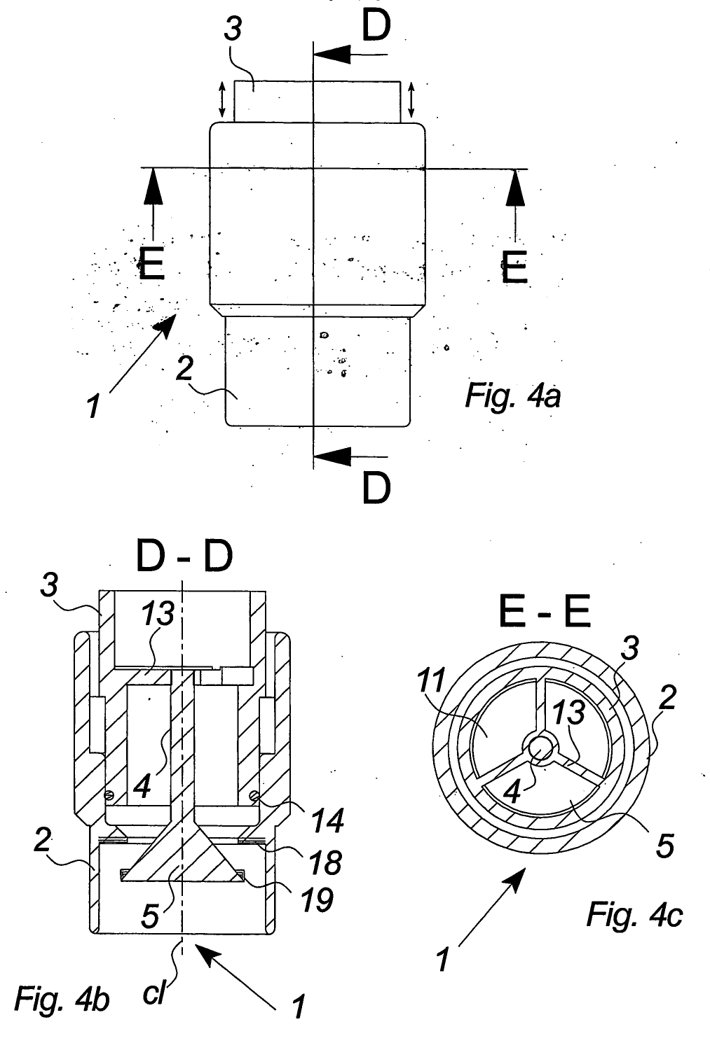

FIG. 4a shows a pouring spout 1 depicting an alternative embodiment of the inner tubular means 2 and the outer tubular means 3.

FIG. 4b shows a sectional drawing of FIG. 4a depicting the outer tubular means 2, whose lower end is to be attached to a container, and the inner tubular means 3 within the outer tubular means 2, and with a sealing means 14 between the inner surface of the outer tubular means 2 and the outer surface of the inner tubular means 3. A magnetic or ferrous material 19 is shown attached to the outer surface of the inner tubular means 3 with a fixed magnetic or ferrous material 18a and 18b attached to the inner surface of the outer tubular means 2 in two different positions. The stick 4 is shown attached to the connection means 13 and passing through the holding means 12. The closing means 5 is shown partially open and positioned on the centre line c1. The magnetic or ferrous materials 18, 19 establish an embodiment of the activating means for the pouring spout 1.

FIG. 4c shows a top view of the pouring spout 1. The inner tubular means 3 is depicted surrounded by the outer tubular means 2. The connection means 13 is shown across the inner passage 11 and attached to the inner tubular means 3. The number of ribs comprised in the connection means 13 establishes a number of openings as a part of the inner passage 11. At the centre of the connection means 13 is shown a section of the stick 4. Further, it is shown how the inner passage 11 ends at the upper surface of the closing means 5.

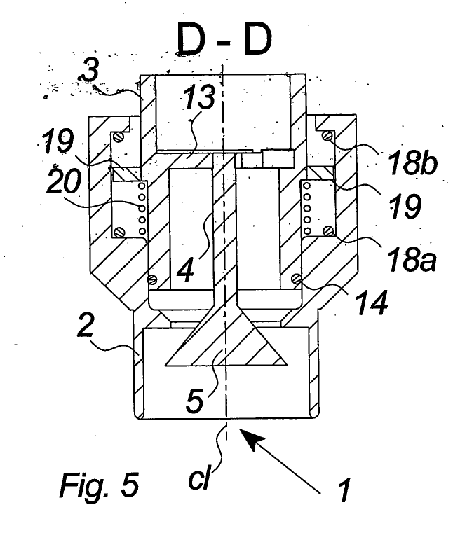

FIG. 5 shows a sectional drawing of FIG. 4a that in all relevant detail corresponds to FIG. 4b, except that in a recess between the inner tubular means 3 and the outer tubular means 2 a spring activating means 20 is positioned. The figure shows the visualization of the activating means 20 as an auxiliary to the movable and fixed magnetic or ferrous means 18a, 18b, 19.

Especially the figure shows an embodiment in which the activating means comprise a combination of the ‘magnet’ closing means 18a, 18b, 19 and the spring activating means 20. The magnets will assist in preventing the unintentional depression of the spring activating means 20 in the case of a container with the invention attached falling from one level to a much lower level.

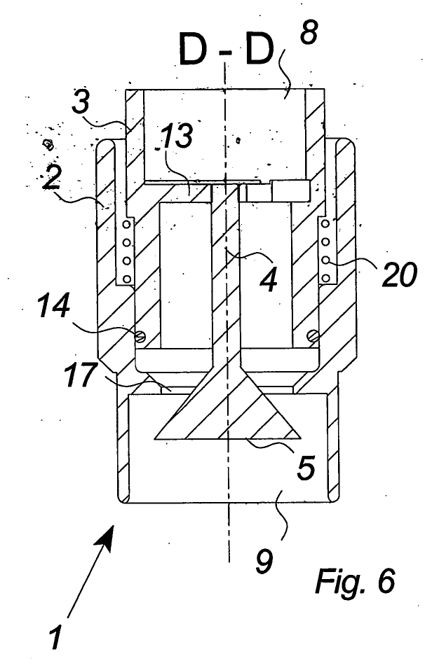

FIG. 6 shows a sectional drawing of an alternative embodiment of the pouring spout 1 depicting the outer tubular means 2, whose lower end is to be attached to a container, and the inner tubular means 3 within the outer tubular means 2, and with a sealing means 16 between the inner surface of the outer tubular means 2 and the outer surface of the inner tubular means 3. In a recess between the inner tubular means 3 and the outer tubular means 2 a spring activating means 20 is positioned. The stick 4 is depicted passing through holding means 12 and is attached to the connection means 13. Under the connection means 13 is shown the opening being closable by the closing means 17 and the closing means 5 shown in the open position. Below the closing means 5 is shown the opening into the container and above the connection means 13 is shown the opening towards the exterior 8.

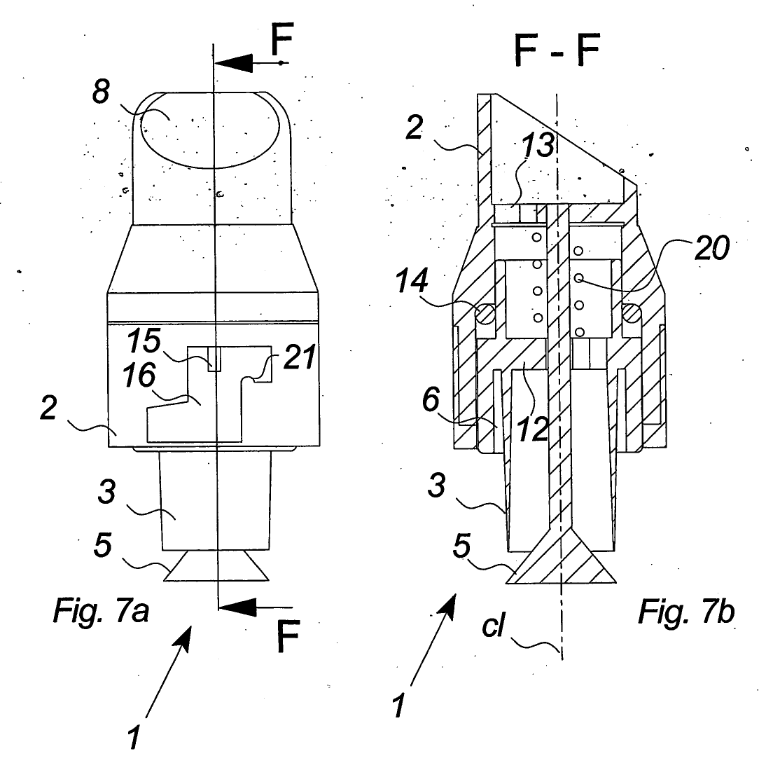

FIG. 7a shows a pouring spout 1, including an alternative opening towards the exterior 8 on the outer tubular means 2. The closing means 5 is shown in an open position. On the outer surface of is a movement area 16 within which is pin 15. In the upper section of the movement area 16 is shown a bulge 21 for securing the pin in position.

FIG. 7b shows a sectional drawing of FIG. 7a depicting the outer tubular means 2 encompassing the inner tubular means 3, the lower end of which is for inserting into the opening of a container. Around the lower end of the inner tubular means is a container connection section 6. Positioned along the centre line c1 within the inner tubular means 3 is the stick 4 with closing means 5. The stick passes through the connection means 12 and is attached to the holding means 13.

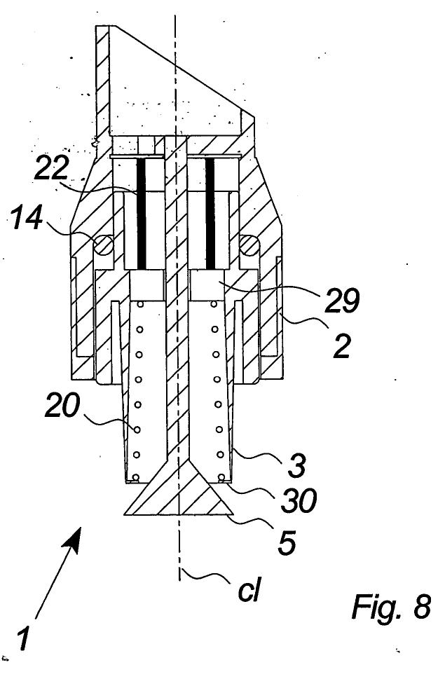

FIG. 8 shows a sectional drawing of an alternative embodiment of a pouring spout, depicting the outer tubular means 2 surrounding the inner tubular means 3, within which the spring means 20 is positioned between sliding holding means 29 and a lip or resting points 30 around the inner surface of the inner tubular means 3 at its lower end. Controlling rods 22 are attached to the upper surface of the sliding holding means 29 and to the lower surface of the holding means. The stick 4 is centrally positioned within the inner tubular means 3. It passes through the sliding holding means 29 and is attached to the connection means. The closing means 5 is depicted in the open position.

The embodiment may include holes in the holding or connection means being of a shape that would allow lateral movement of the connecting rods in order to achieve the ‘pin and recess’ functionality.

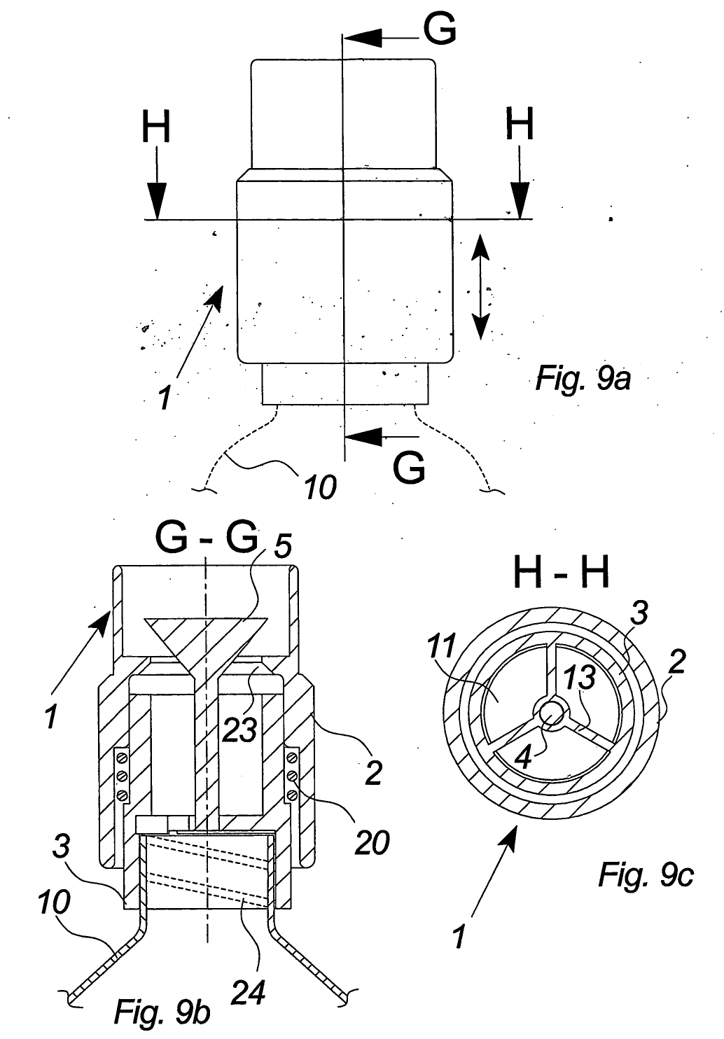

FIG. 9a shows a pouring spout 1 in an alternative embodiment.

FIG. 9b shows a sectional drawing of FIG. 9a that illustrates the alternative embodiment. The outer tubular means 2 encompasses the inner tubular means and in a recess between these is positioned a spring activating means 20. An inner thread 24 is shown on the inner surface of the inner tubular means 3 in the area at the bottom of the inner tubular means that is intended to encompass the rim of the opening of a container. Above the area with the inner thread 24 is located a holding means to which is attached the stick. The stick passes through a connection means that is positioned below an opening 23 being closable by the closing means 5, which is shown in the open position within the mouthpiece of the pouring spout.

FIG. 9c shows a sectional drawing of FIG. 9a, depicting the inner tubular means 3 surrounded by the outer tubular means 2. The connection means 13 is shown across the inner passage 11 and attached to the inner tubular means 3. At the centre of the connection means 13 is shown the stick 4.

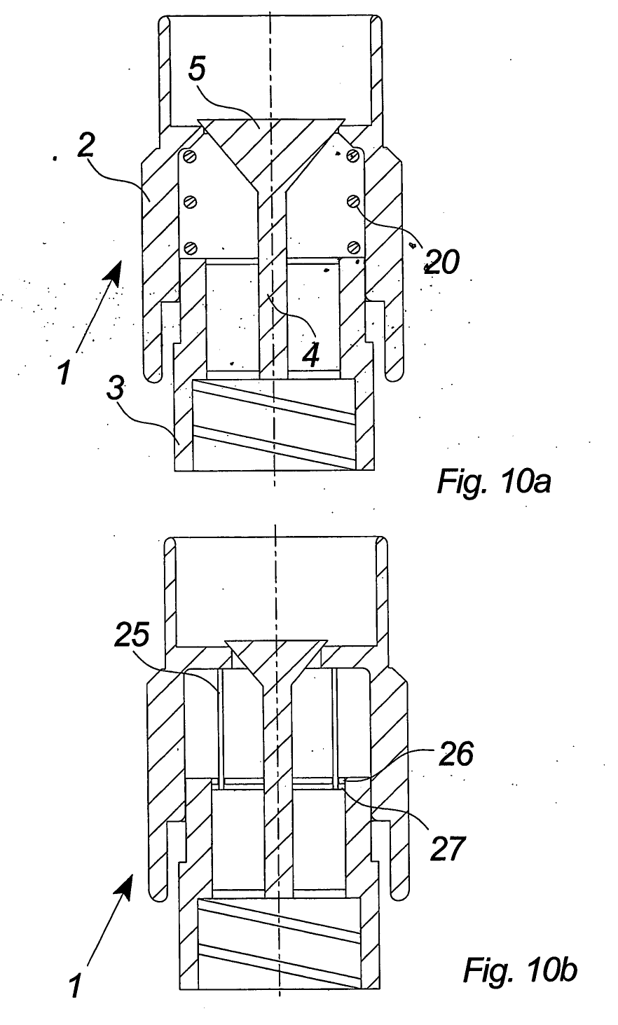

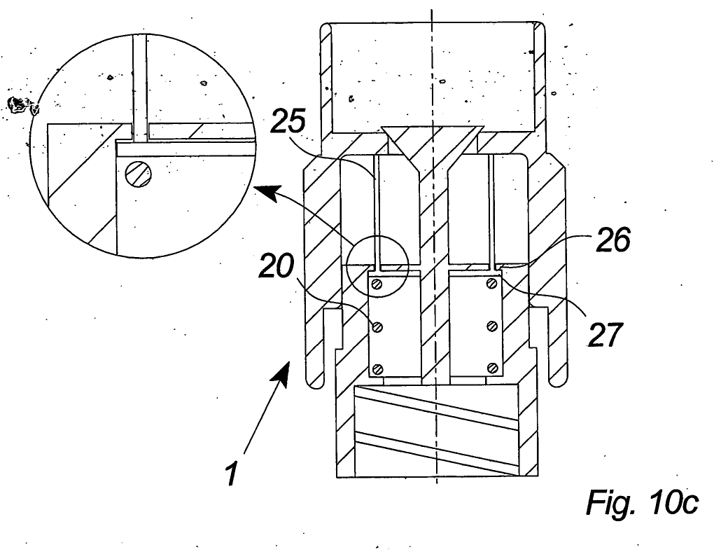

FIG. 10a shows a sectional drawing of an alternative embodiment of a pouring spout The outer tubular means 2 encompasses the inner tubular means 3. A spring activating means 20 is positioned with its lower end resting on the upper rim of the inner tubular means 3 and its upper end held within the top section of the outer tubular means 2, just under the opening being closable by the closing means. The stick 4 is attached to a connection means, just above the opening into the container, and passes through a holding means. The closing means 5, positioned together with the stick 4 centrally within the inner tubular means 3 and the outer tubular means 2, is depicted in the closed position within the mouthpiece of the outer tubular means 2, below the opening towards the exterior.

FIG. 10b shows a sectional drawing of a pouring spout, depicting the outer tubular means encompassing the inner tubular means. Immediately above the entrance into the container a connection means is positioned to which the stick is attached. The stick passes upwards through a magnetic material in connection with a fixed plate 26 and a material sensible to magnetic fields 27. The closing means is shown in the closed position in the opening being closable by the closing means. From the area around the opening, controlling rods attached to said area project downward to and through the magnetic material in connection with a fixed plate 26 and to the material sensible to magnetic fields to which they are also attached. The fixed plate 26 is of a configuration that allows lateral movement. This functionality is necessary in order to achieve the ‘pin and recess’ functionality.

FIG. 10c shows a sectional drawing of that in all relevant detail corresponds to FIG. 10b, except that it shows a spring activating means 20 positioned under the material sensible to magnetic fields and resting on the connection means situated immediately above the entrance into the container.

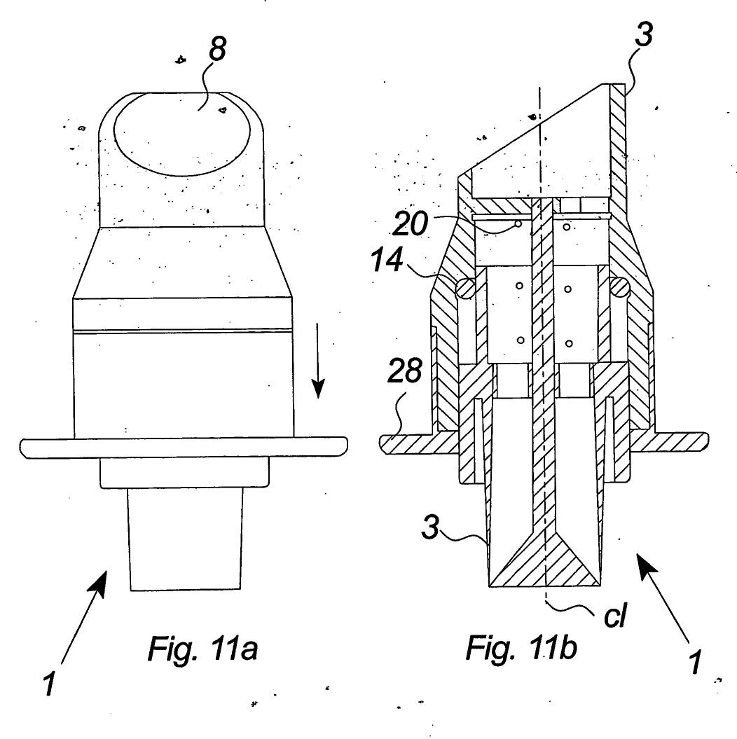

FIG. 11a shows an alternative embodiment of a pouring spout, in which the opening towards the exterior and the collar 28 indicate the alternatives.

FIG. 11b shows a sectional drawing of FIG. 10a, depicting the attachment of the collar 28 to the outer tubular means 2.

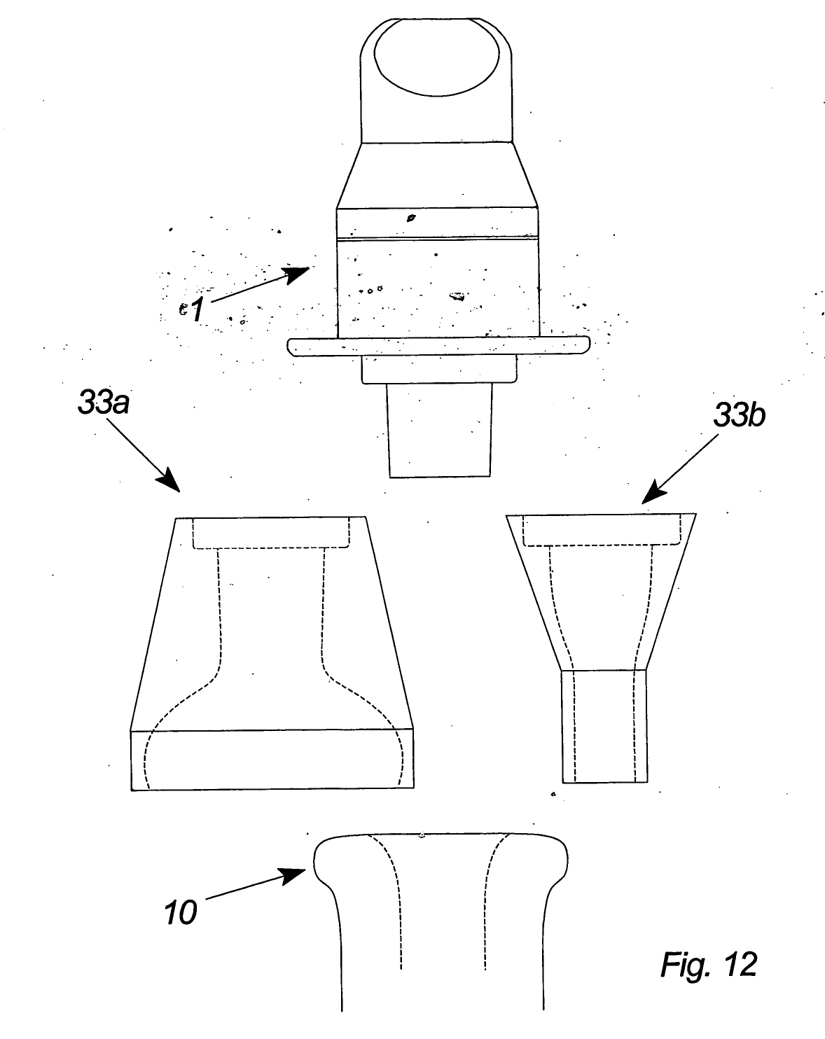

FIG. 12 shows the incorporation of physical adapting means 33a, 33b that could be placed between the container 10 and the pouring spout 1 in cases where the diameter of the neck of the container do not correspond to the diameter of the inner or outer tubular means. The cases in question would be as follows:

a) An adaptor 33a that at one end fits around or inside the neck of the container and in the other end fits a configuration of the invention whose external diameter is greater than the neck of the container, and

b) An adaptor 33b that at one end fits around or inside the neck of the container and in the other end fits a configuration of the pouring sprout 1 whose external diameter is less than the neck of the container.

The connection between the adapting means and the pouring spout and between the adapting means and the neck or the opening of the container may e.g. be established by screw threads or by close-fits.

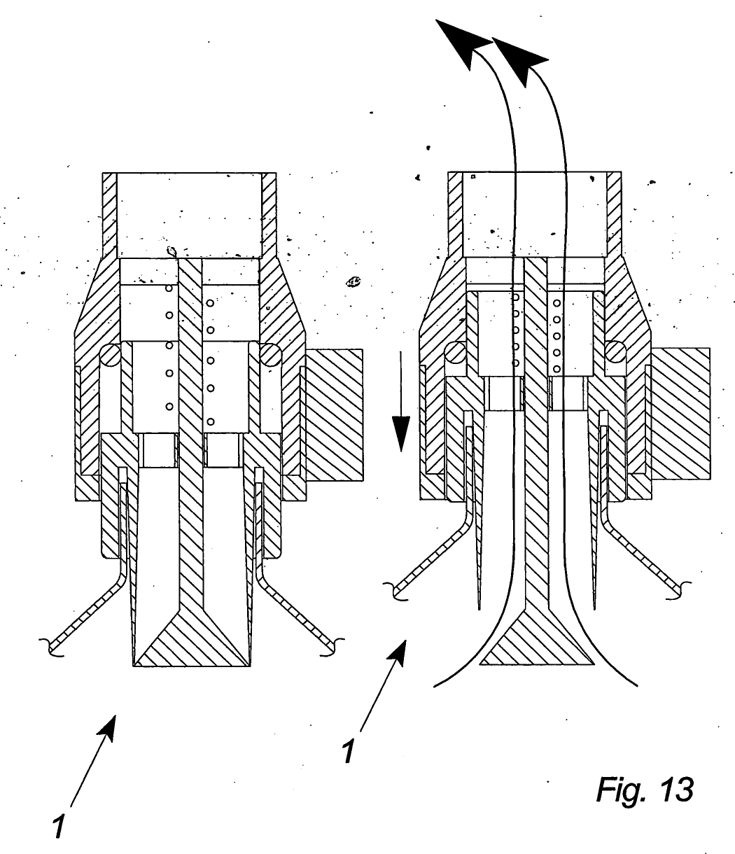

FIG. 13 shows the functionality of an embodiment of the pouring spout 1 in a closed and opened position (to the left and right, respectively) in which the embodiment corresponds to the pouring spout 1 of FIGS. 3a and 3b. The flow of liquid through the ¢open” pouring spout 1 is shown with two arrows including the flow through the openings of the holding and connection means 12, 13.

The invention has been exemplified above with reference to specific examples. However, it should be understood that the invention is not limited to the particular examples described above but may be used in connection with a wide variety of applications. It should also be understood that especially the opening and closing mechanisms according to the invention may be designed in a multitude of varieties within the scope of the invention as specified in the claims.

Further, the pouring spout and especially the outer tubular means may comprise surfaces capable of receiving printing text or labels e.g. including commercial messages or brands.

List

| | |
|---|---|
| 1. | Pouring spout |
| 2. | Outer tubular means |
| 3. | Inner tubular means |
| 4. | Stick |
| 5. | Closing means |
| 6. | Container connection section |
| 7. | Adaptor for holding a normal closing means of the |
| | container e.g. the cap, cork or stopper of a bottle |
| 8. | Opening towards the exterior |
| 9. | Opening into the container |
| 10. | Container and especially rim or neck of the container |
| 11. | Inner passage |
| 12. | Holding means including openings being part of the inner |
| | passage |
| 13. | Connection means including openings being part of the |
| | inner passage |
| 14. | Sealing means such as O-rings or rims in rubber material |
| 15. | Pin |
| 16. | Movement area |
| 17. | Opening being closable by the closing means |
| 18a, 18b. | Fixed magnetic or ferrous material |
| 19. | Movable magnetic or ferrous material |
| 20. | Spring activating means |
| 21. | Bulge securing the pin in a position |
| 22. | Controlling rod or rods |
| 23. | Opening being closable by the closing means |
| 24. | Inner thread |
| 25. | Controlling rod or rods |
| 26. | Magnetic material in connection with a fixed plate |
| 27. | Material sensible to magnetic fields |
| 28. | Collar |
| 29. | Sliding holding means |
| 30. | Lip or resting points |
| 33a, 33b, | Adapting means for adapting the pouring spout to the |
| | internal or the external diameter of the container |
| cl | centre line |

1. Pouring spout (1) for a container for liquid, said spout comprising
outer tubular means (2)
inner tubular means (3) with an inner passage (11) to facilitate said liquid from the container to the exterior,
said inner tubular means (3) being partly or totally integrated in said outer tubular means (2) and said means being movable in relation to each other,
characterized by
said spout further comprises a stick (4) including closing means (5) at one end for closing or opening said inner passage (11) by movement of said outer or inner tubular means in relation to each other.

2. Pouring spout (1) according to claim 1, characterized by said stick (4) including closing means (5) is moved from a first position to one or more further positions in which one or more of said positions are defined.

3. Pouring spout (1) according to claim 1 or 2, characterized by said inner tubular means (3) being connected to the container e.g. by entering into an opening of said container or by surrounding a rim of an opening of said container or by being attached to the edge of the rim of said container.

4. Pouring spout (1) according to any of claims 1 to 3, characterized by said spout includes a section comprising an opening (8) with a rim for pouring to the exterior, said section being opposite the section comprising an opening (9) into the interior of the container and said openings (8, 9) each defines a beginning of said inner passage (11).

5. Pouring spout (1) according to claim 4, characterized by said closing means (5) closing and opening at one of said two openings (8, 9).

6. Pouring spout (1) according to any of claims 1 to 5, characterized by a container connection section (6) comprises sealing means such as O-rings or rims in rubber-like material.

7. Pouring spout (1) according to any of claims 1 to 6, characterized by said stick, (4) being connected to said outer or inner tubular means (2, 3) with holding or connection means (12, 13) comprising one or more openings.

8. Pouring spout (1) according to claim 7, characterized by said one or more openings in said holding or connection means (12, 13) being part of said inner passage (11).

9. Pouring spout (1) according to any of claims 1 to 8, characterized by said stick (4) being positioned in the centre of said inner and/or outer tubular means (2, 3) along a centre line (c1) of said inner and/or outer tubular means (2, 3).

10. Pouring spout (1) according to any of claims 7 to 9, characterized by said stick (4) transversally being held in place by holding means (12) extending from the inner surface of said inner tubular means, said holding means (12) allowing the stick (4) to move in the longitudinal direction.

11. Pouring spout (1) according any of claims 1 to 10, characterized by said holding means (12) being at least one ring or similar shaped means connected to said inner surface of said inner tubular means (3) with supporting arms.

12. Pouring spout (1) according any of claims 1 to 11, characterized by said outer tubular means (2) being movable in the longitudinal direction in relation to said inner tubular means (3) and by a circular movement around said centre line (c1).

13. Pouring spout (1) according to any of claims 1 to 12, characterized by said outer tubular means (2) includes at least one opening defining a movement area (16) of at least one pin (5) connected to the outer surface of said inner tubular means (3).

14. Pouring spout (1) according to any of claims 1 to 12, characterized by said inner tubular means (3) includes at least one recess defining a movement area (16) of at least one pin (15) connected to the inner surface of said outer tubular means (2).

15. Pouring spout (1) according to claim 13 or 14, characterized by said movement area (16) comprises at least two openings or recesses being perpendicular or parallel to said centre line (c1).

16. Pouring spout (1) according to claim 15, characterized by a first and further openings or recesses being perpendicular to each other forming one or more successive S shapes.

17. Pouring spout (1) according to any of claims 14 to 16, characterized by said movement area comprising a first and third opening or recess being perpendicular to the centreline (c1) and establishing two defined positions for said stick (4) including closing means (5) e.g. an opened and closed position for said inner passage (11).

18. Pouring spout (1) according to any of claims 14 to 17, characterized by said first and/or third opening or recess comprise at least one bulge (21) securing said at least one pin (15) in one of said defined positions.

19. Pouring spout according to any of claims 7 to 18, characterized by said stick (4) further comprises at least one controlling rod (22, 25) movable held in one or more of said holding or connection means (12, 13) e.g. sliding in holes penetrating said holding or connection means (12 13).

20. Pouring spout according to claim 19, characterized by said at least one controlling rod (22, 25) being positioned between said stick (4) and the inner surface of said inner tubular means (3) e.g. in sets on opposite side of the stick (4).

21. Pouring spout according to any of claims 1 to 20, characterized by said inner and outer tubular means (2, 3) comprise activating means (18-20, 26, 27) such as spring or magnetic means or combinations of the two.

22. Pouring spout according to claim 21, characterized by said activating means includes spring activating means (20) acting against an interior surface of said inner and outer tubular means (2, 3), or against an interior surface of said inner tubular means and said holding means, or against an interior surface of said tubular means and said connecting means (13).

23. Pouring spout according to claim 21 or 22, characterized by said activating means includes spring activating means (20) acting against at least two surfaces of spout such as
an inner surface of said inner tubular means (2) and an outer surface of said outer tubular means (3),
an outer surface of said inner tubular means (2) and an inner surface of said outer tubular means (3),
an inner surface of said inner tubular means (2) and an upper surface of said outer tubular means (3),
surfaces of said holding means (12) and said connecting means (13),
a surface of said material sensible to magnetic fields (27) and an lower surface of said outer tubular means (3),
or surfaces of said sliding holding means (29) and lip or resting points (30).

24. Pouring spout according to any of claims 21 to 23, characterized by said activating means includes magnetic material (18, 19, 26, 27) in connection with said stick (4) and material (18, 19, 26, 27) sensible to magnetic fields in connection with said inner tubular means (3) or vice versa.

25. Pouring spout according to any of claims 21 to 24, characterized by said activating means includes magnetic material (18, 19, 26, 27) in connection with said stick (4) and material (18, 19, 26, 27) sensible to magnetic fields in connection with said inner tubular means (3) or vice versa and spring activating means (20) acting against an interior surface of said inner or outer tubular means (2, 3) and a surface of said connection means (13) in order to force said stick (4) including closing means (5) toward a closing position of said inner passage (11).

26. Pouring spout according to any of claims 1 to 25, characterized by some or all means of the pouring spout such as said inner and outer tubular means (2, 3) being made in a plastic material or any material capable of being moulded, extruded, milled or similarly modified.

27. Pouring spout according to any of claims 1 to 26, characterized by said closing means (5) being made in a rubber material other similarly flexible material.

28. Pouring spout according to any of claims 1 to 27, characterized by the surface of said spout comprising an adaptor (7) for holding a normal closing means of the container.

29. Pouring spout according to claim 28, characterized by said adaptor (7) comprising a rim and a screw thread corresponding to the cap of the container.

30. Container (10) for containing a liquid being pourable through at least one opening in said container, where said container includes a pouring spout (1) according to any of claims 1 to 29 controlling the pouring of said liquid through said at least one opening.

31. Container (10) according to claim 30, characterized by said pouring spout (1) being an integrated part of said container or a separate part mounted on said container.

32. Container (10) according to claim 30 or 31, characterized by said pouring spout (1) being a separate part mounted on said container with an adapting means (33) in between the spout and the neck or opening of said container for adapting diameters of said spout and neck or opening.

33. Method of controlling the liquid pouring from a container with a pouring spout, said method comprising the steps of:
moving an outer or inner tubular means of the pouring spout in relation to each other,
and hereby
moving a stick including closing means of the pouring spout from a first position to one or more further positions which one or more of said positions are defined.

34. Method according to claim 33, where the stick including closing means may be moved between at least the following positions
a first defined position closing the liquid passage of the sprout by said closing means being forced against an opening of the liquid passage,
a second defined position in which the liquid passage of the sprout is open by said closing means being held at a distance from said opening of the passage, and
at least one further position allowing said closing means moving freely between said first and second defined position.

35. Use of a pouring spout according to any of claims 1 to 29 in connection with beverage containers such as bottles containing milk, juice, lemonade, wine, beer or soft drink e.g. drinks comprising carbon dioxide.

35. (canceled)

36. Pouring spout for a container for liquid, said spout comprising:
outer tubular means;
inner tubular means with an inner passage to facilitate said liquid from the container to the exterior, said inner tubular means being partly or totally integrated in said outer tubular means and said means being movable in relation to each other;
a stick including closing means at one end for closing or opening said inner passage by movement of said outer or inner tubular means in relation to each other, said stick including closing means being movable from a first defined position where said inner passage is closed to one or more further positions at least one of which is defined and at least one of which is a second defined position where said inner passage is open; and
a movement area of a pin cooperating with each other to provide for at least the following principles of usage:
maintenance of said outer and inner tubular means in relation to each other in said first defined position where said inner passage is closed,
maintenance of said outer and inner tubular means in relation to each other in said second defined position where said inner passage is open, and
free movement of said outer and inner tubular means in relation to each other at least between said first and second defined positions.

37. Pouring spout according to claim 36 wherein said inner tubular means is connected to the container by entering into an opening of said container or by surrounding a rim of an opening of said container or by being attached to an edge of the rim of said container.

38. Pouring spout according to claim 36, wherein said spout includes a section comprising an opening with a rim for pouring to the exterior, said section being opposite the section comprising an opening into the interior of the container and said openings each defines a beginning of said inner passage.

39. Pouring spout according to claim 38, wherein said closing means is configured for closing and opening at one of said two openings.

40. Pouring spout according to claim 36, wherein a container connection section comprises sealing means including O-rings or rims in rubber or rubber-like material.

41. Pouring spout according to claim 36, wherein said stick is connected to said outer or inner tubular means with holding or connection means comprising one or more openings.

42. Pouring spout according to claim 41, wherein said one or more openings in said holding or connection means is part of said inner passage.

43. Pouring spout according to claim 42, wherein said stick is positioned in a center of said inner and/or outer tubular means along a centre line of said inner and/or outer tubular means.

44. Pouring spout according to claim 43, wherein said stick is transversally held in place by holding means extending from an inner surface of said inner tubular means, said holding means allowing the stick to move in a longitudinal direction.

45. Pouring spout according to claim 44, wherein said holding means comprises at least one ring or similar shaped means connected to said inner surface of said inner tubular means with supporting arms.

46. Pouring spout according to claim 44, wherein said outer tubular means is movable in the longitudinal direction in relation to said inner tubular means and by a circular movement around said centre line.

47. Pouring spout according to claim 36, wherein said movement area is defined by at least one opening included by said outer tubular means and said at least one pin being connected to an outer surface of said inner tubular means.

48. Pouring spout according to claim 36, wherein said movement area is defined by at least one recess included by said inner tubular means and said at least one pin being connected to an inner surface of said outer tubular means.

49. Pouring spout according to claim 47, wherein said movement area comprises at least two openings or recesses being perpendicular or parallel to a centre line of said inner or outer tubular means.

50. Pouring spout according to claim 49, wherein a first and further openings or recesses are perpendicular to each other forming one or more successive S shapes.

51. Pouring spout according to claim 49, wherein said movement area comprises a first and third opening or recess being perpendicular to the centreline and establishing two defined positions for said stick including closing means having an opened and closed position for said inner passage.

52. Pouring spout according to claim 51, wherein said first and/or third opening or recess comprise at least one bulge securing said at least one pin in one of said defined positions.

53. Pouring spout according to claim 41, wherein said stick further comprises at least one controlling rod movably held in one or more of said holding or connection means.

54. Pouring spout according to claim 53, wherein said at least one controlling rod is positioned between said stick and an inner surface of said inner tubular means.

55. Pouring spout according to claim 36, wherein said inner and outer tubular means comprise activating means such as spring or magnetic means or combinations of the two.

56. Pouring spout according to claim 55, wherein said activating means includes spring activating means acting against an interior surface of said inner and outer tubular means, or against an interior surface of said inner tubular means and said holding means, or against an interior surface of said tubular means and said connecting means.

57. Pouring spout according to claim 55, wherein said activating means includes spring activating means acting against at least two surfaces of said spout such as
an inner surface of said inner tubular means and an outer surface of said outer tubular means,
an outer surface of said inner tubular means and an inner surface of said outer tubular means,
an inner surface of said inner tubular means and an upper surface of said outer tubular means,
surfaces of said holding means and said connecting means,
a surface of said material sensible to magnetic fields and an lower surface of said outer tubular means,
or surfaces of said sliding holding means and lip or resting points.

58. Pouring spout according to claim 55, wherein said activating means includes magnetic material in connection with said stick and material sensible to magnetic fields in connection with said inner tubular means or vice versa.

59. Pouring spout according to claim 55, wherein said activating means includes magnetic material in connection with said stick and material sensible to magnetic fields in connection with said inner tubular means or vice versa and spring activating means acting against an interior surface of said inner or outer tubular means and a surface of said connection means in order to force said stick including closing means toward a closing position of said inner passage.

60. Pouring spout according to claim 36, wherein some or all means of the pouring spout such as said inner and outer tubular means are made in a plastic material or any material capable of being moulded, extruded, milled or similarly modified.

61. Pouring spout according to claim 36, wherein said closing means are made in a rubber material or other similarly flexible material.

62. Pouring spout according to claim 36, wherein a surface of said spout comprises an adaptor for holding a normal closing means of the container.

63. Pouring spout according to claim 62, wherein said adaptor comprises a rim and a screw thread corresponding to a cap of the container.

64. Container for containing a liquid being pourable through at least one opening in said container, where said container includes a pouring spout according to claim 36, for controlling a pouring of said liquid through said at least one opening.

65. Container according to claim 64, wherein said pouring spout is an integrated part of said container or a separate part mounted on said container.

66. Container according to claim 64, wherein said pouring spout is a separate part mounted on said container with an adapting means in between the spout and a neck or opening of said container for adapting diameters of said spout and neck or opening.

67. Method of controlling liquid pouring from a container with a pouring spout, said method comprising:
moving an outer or inner tubular means of the pouring spout in relation to each other;
moving a stick including closing means of the pouring spout between at least the following positions:
a first defined position closing a liquid passage of the spout by said closing means being forced against an opening of the liquid passage,
a second defined position in which the liquid passage of the spout is open by said closing means being held at a distance from said opening of the passage, and
at least one further position allowing said closing means to move freely between said first and second defined position; and
providing for maintaining said stick including closing means of the pouring spout in one of said defined positions by providing said pouring spout with a movement area and a pin cooperating with each other.

68. Container according to claim 36, wherein said container comprises a beverage containers such as a bottle containing milk, juice, lemonade, wine, beer or soft drink, and drinks comprising carbon dioxide.
